(19) United States
(12) Patent Application Publication
(10) Pub. No.: US 2024/0320027 A1
(43) Pub. Date: Sep. 26, 2024

(54) MULTI-SCREEN ALLOCATION MANAGEMENT METHOD AND APPARATUS OF A PLURALITY OF VIRTUAL MACHINES

(71) Applicant: Samsung Electronics Co., Ltd., Suwon-si (KR)

(72) Inventors: Penghui QIAO, Shaanxi Province (CN); Xiaoyao MIN, Shaanxi Province (CN); Yuanling SUN, Shaanxi Province (CN)

(21) Appl. No.: 18/409,104

(22) Filed: Jan. 10, 2024

(30) Foreign Application Priority Data
Mar. 24, 2023 (CN) 202310301762.4

(51) Int. Cl. G06F 9/455

(52) U.S. Cl. CPC G06F 9/45558

(57) ABSTRACT

A multi-screen allocation management method and apparatus for a plurality of virtual machines are provided. The multi-screen allocation management method of the plurality of virtual machines includes allocating a first display resource to a first virtual machine based on display resource management policy information in response to the first virtual machine starting; and recycling and reallocating the allocated display resource from the first virtual machine based on the display resource management policy information in response to the first virtual machine closing. The display resource management policy information comprises information of at least one display resource configured for each of the plurality of virtual machines, and the first display resource is at least one display resource configured for the first virtual machine.

### CROSS-REFERENCE TO RELATED APPLICATIONS

This application claims the benefit under 35 U.S.C. 119 to Chinese application 202310301762.4, filed on Mar. 24, 2023 within the China National Intellectual Property Administration (CNIPA), the entire contents of which are herein incorporated by reference.

### BACKGROUND

Various example embodiments relate to display field, and more particularly to a multi-screen allocation management method and/or apparatus of a plurality of virtual machines.

With the continuous enhancement of chip performance, one application processor (AP) chip may support the connection and simultaneous operation of or for a plurality of screens. For example, one chip may support up to or more than six video outputs. Based on the application of such kind of chips in a digital cockpit system (for example in an automobile digital cockpit system), information and entertainment experiences similar to a smart phone may be provided to the user. Compared with the use of one dedicated device by each user of a smart phone, the digital cockpit system may provide different display resources for different users (such as passengers) to achieve a user experience similar to that of the smart phone. FIG. 1 is a diagram of a digital cockpit system. As illustrated in FIG. 1, the screen in a back seat displays a game interface, and the other screen displays a music interface.

Currently, the mainstream solution of a digital cockpit system is a one-chip multi-screen solution; in which a plurality of virtual machines (VMs) are created through a virtualization technology, and different screens are assigned to different virtual machines, so that different users can use different virtual machines. Meanwhile, content sharing among multiple screens is also a feature of the current digital cockpit system. FIG. 2 is a diagram illustrating content sharing among multiple screens. As illustrated in FIG. 2, the digital cockpit system may include displays such as five displays 201-205 and four virtual machines 210-240. The contents (such as one or more of multimedia information, navigation information, etc.) in an In-Vehicle Infotainment OS (IVI OS) operating in virtual machine 220 may be shared to an instrument cluster operating system (Cluster OS) operating in virtual machine 210.

However, for the existing one-chip multi-screen solution based on virtualization technology, display resources cannot change after being allocated to virtual machines. The virtual machines can only use the allocated fixed display resources, and after the virtual machine is shut down or closed or released, the corresponding display resources are idle, and dynamic expansion of the display resources cannot be realized. Alternatively or additionally, it is also impossible or improbable to realize the dynamic expansion of display resources and that the virtual machine uses display resources on different screens at the same time.

### SUMMARY

In accordance with various example embodiments, a multi-screen allocation management method of a plurality of virtual machines is provided, which includes: allocating a first display resource to a first virtual machine based on display resource management policy information in response to the first virtual machine starting; and recycling and reallocating the allocated display resource from the first virtual machine, the recycling and reallocating based on the display resource management policy information, the recycling and reallocating in response to the first virtual machine closing. The display resource management policy information includes information of at least one display resource configured for each of the plurality of virtual machines, and the first display resource is at least one display resource configured for the first virtual machine.

In accordance with various example embodiments, a multi-screen allocation management apparatus of a plurality of virtual machines is provided, which includes: a display resource allocation management module configured to allocate a first display resource to a first virtual machine based on display resource management policy information in response to the first virtual machine starting, and recycle and reallocate the allocated display resource from the first virtual machine based on the display resource management policy information in response to the first virtual machine closing. The display resource management policy information comprises information of at least one display resource configured for each of the plurality of virtual machines, and the first display resource is at least one display resource configured for the first virtual machine.

In accordance with various example embodiments, an electronic device is provided, which includes a memory on which computer executable instructions are stored and a processor which executes the previous method when the instructions are executed by the processor.

In accordance with various example embodiments, a computer readable medium is provided, on which computer executable instructions are stored, which executes the previous method when the instructions are executed.

In accordance with various example embodiments, the ability to dynamically expand display resources may be provided by reallocating display resources based on display resource management policy information when the virtual machine is shut down. Applications in the virtual machines may be enabled to dynamically use a plurality of display resources by allocating a plurality of displays and/or layers in a plurality of displays to the virtual machine so that application scenarios in a multi-screen scenario are expanded. Alternatively or additionally, customization developments of application level software may be reduced, e.g. reduced as much as possible through development of the driver level, that is, disposing modules such as the display resource allocation management module and/or the like in the virtual machine which actually controls display resources in the plurality of virtual machines.

### BRIEF DESCRIPTION OF DRAWINGS

The above and other destinations and features will become more apparent through the following detailed descriptions with reference to the attached drawings, in which:

FIG. 1 is a diagram of a digital cockpit system;

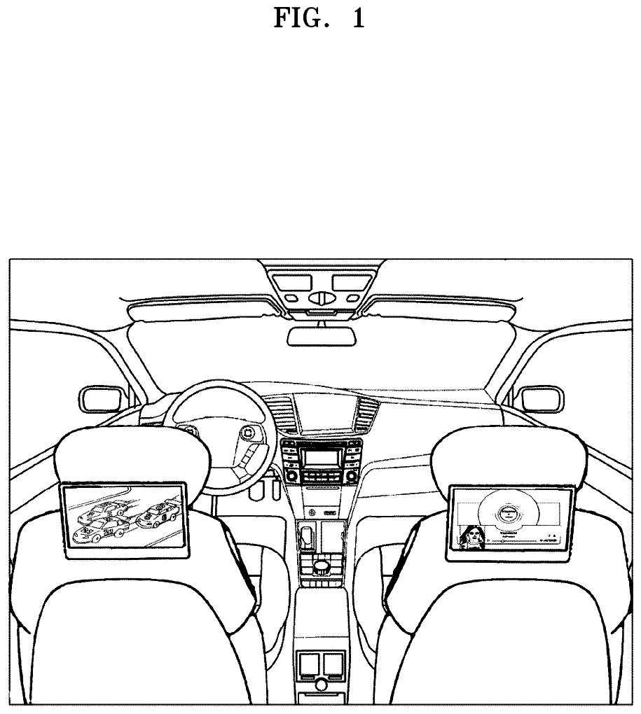

FIG. 2 is a diagram illustrating content sharing among multiple screens;

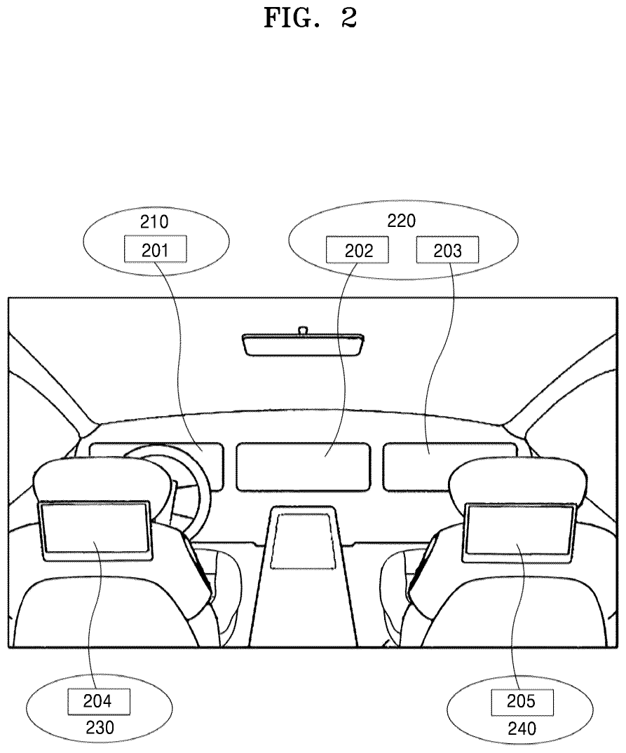

FIG. 3 illustrates a flow diagram of a multi-screen allocation management method of a plurality of virtual machines in accordance with various example embodiments;

FIG. 4 is a block diagram illustrating a multi-screen allocation management apparatus of a plurality of virtual machines in accordance with various example embodiments;

FIG. 5 is a diagram illustrating a multi-screen allocation management apparatus of a plurality of virtual machines in accordance with various example embodiments;

FIG. 6 is a diagram illustrating a multi-screen allocation management apparatus of a plurality of virtual machines operating virtual machines 1 and 2 according to Table 1 in accordance with various example embodiments;

FIG. 7 is a diagram illustrating a multi-screen allocation management apparatus of a plurality of virtual machines operating virtual machine 3 according to Table 1 in accordance with various example embodiments; and

FIG. 8 is a diagram illustrating a multi-screen allocation management apparatus of a plurality of virtual machines operating virtual machine 4 according to Table 1 in accordance with various example embodiments.

### DETAILED DESCRIPTION

Now examples of various example embodiments are illustrated in the drawings with detailed reference to various embodiments, wherein the same label consistently indicates the same component. Embodiments will be described in detail below by referring to the accompany drawings to explain the present disclosure.

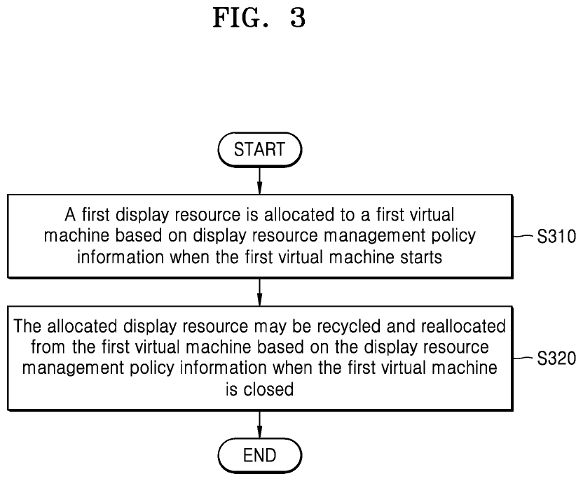

FIG. 3 illustrates a flow diagram of a multi-screen allocation management method of a plurality of virtual machines in accordance with various example embodiments.

As illustrated in FIG. 3, in S310, a first display resource is allocated to a first virtual machine based on display resource management policy information when the first virtual machine starts, or in response to the first virtual machine starting. Here, the display resource management policy information may include information of at least one display resource configured for each of the plurality of virtual machines, and the first display resource may be at least one display resource configured for the first virtual machine. In some example embodiments, the display resource management policy information may further include information of at least one primary display resource and at least one expansion display resource, the at least one expansion display resource configured for each virtual machine. Here, the primary display resource may be or may only set as the primary display resource of one virtual machine so as to avoid conflict of primary display resources among the plurality of virtual machines. For example, if the first primary display resource is the primary display resource of the first virtual machine, then the first primary display resource will not be set to be the primary display resource of the other virtual machines. Additionally or alternatively, the expansion display resource may be set to be the expansion display resource of one virtual machine, and may also be set to be the expansion display resource of a plurality of virtual machines. Alternatively or additionally, only as an example rather than the limitation, the display resource may include a plurality of displays and/or layers in a plurality of displays, and the layers may be or may include hardware layers in the displays. It should be noted that the display resource management policy information may be dynamically configured and/or pre-configured and acquired, and may also be set or modified by artisans and/or users according to actual situations.

Only as an example rather than the limitation, in a case that the display resource management policy information includes information of at least one primary display resource and at least one expansion display resource configured for each virtual machine, the idle expansion display resource of the at least one expansion display resource and the at least one primary display resource may be allocated to the first virtual machine based on the display resource management policy information when the first virtual machine starts or in response to the first virtual machine starting. More particularly, the at least one primary display resource may be directly allocated to the first virtual machine in a case that the at least one primary display resource is not allocated to the other virtual machines, and the at least one primary display resource may be recycled from the other virtual machines to allocate to the first virtual machine in a case that the at least one primary display resource is allocated to other virtual machines.

At S320, the allocated display resource may be recycled and/or reallocated from the first virtual machine based on the display resource management policy information when the first virtual machine is closed, or in response to the first virtual machine closing.

Only as an example rather than the limitation, the display resource allocated to the first virtual machine may be recycled and the recycled display resource may be allocated to the operating virtual machine of the other corresponding virtual machines based on the display resource management policy information when the first virtual machine is closed or in response to the first virtual machine closing. Here, the display resource may be allocated by sending, to the first virtual machine, a display resource virtual hot insertion message indicating the display resource to be allocated, and/or the display resource may be recycled by sending, to the first virtual machine, a display resource virtual hot pullout message indicating the display resource to be recycled.

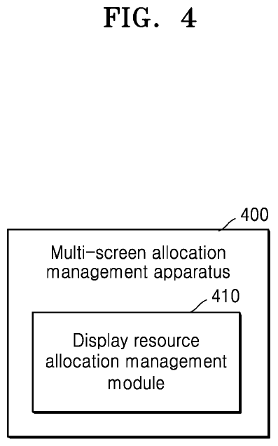

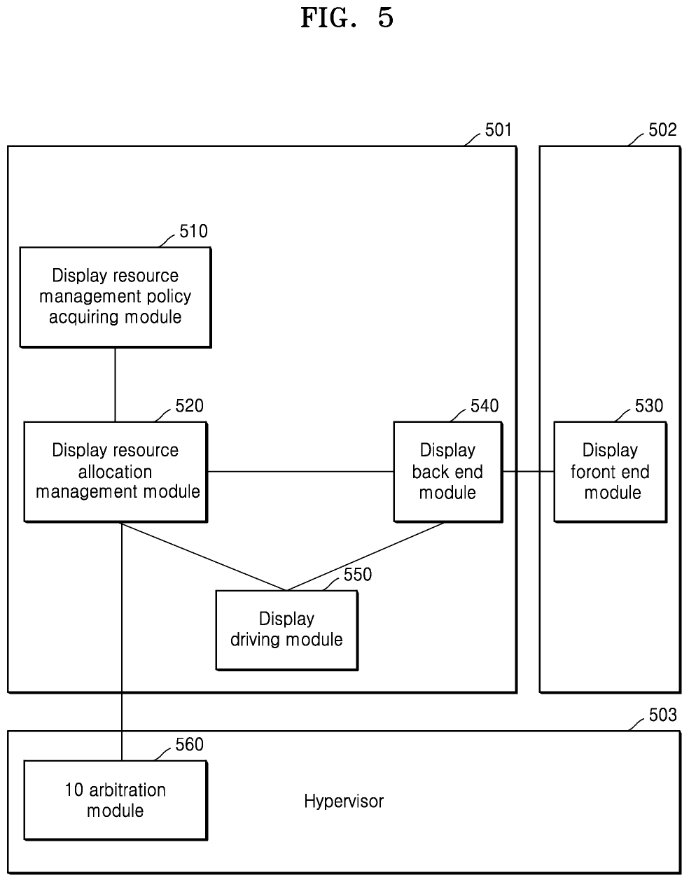

The multi-screen allocation management apparatus of a plurality of virtual machines in accordance with various example embodiments will be described in more details with reference to FIGS. 4 and 5.

FIG. 4 is a block diagram illustrating a multi-screen allocation management apparatus of a plurality of virtual machines in accordance with various example embodiments, and FIG. 5 is a diagram illustrating a multi-screen allocation management apparatus of a plurality of virtual machines in accordance with various example embodiments.

As illustrated in FIG. 4, a multi-screen allocation management apparatus 400 of a plurality of virtual machines in accordance with various example embodiments may include a display resource allocation management module 410 or display resource allocation management processing circuitry.

The display resource allocation management module 410 may be configured to allocate a first display resource to the first virtual machine based on display resource management policy information when the first virtual machine starts or in response to the first virtual machine starting, and may recycle and reallocate the allocated display resources from the first virtual machine based on the display resource management policy information when the first virtual machine is closed or in response to the first virtual machine closing, wherein the display resource management policy information includes information of at least one display resource configured for each of the plurality of virtual machines, and the first display resource is at least one display resource configured for the first virtual machine. More particularly, the display resource management policy information may further include information of at least one primary display resource and at least one expansion display resource configured for each virtual machine. Alternatively or additionally, only as an example rather than the limitation, the display resource may include a plurality of displays and/or layers in a plurality of displays, and the layers may be hardware layers in the displays.

Only as an example rather than the limitation, the display resource management policy information may be dynamically configured and/or pre-configured and acquired. Thus, the multi-screen allocation management apparatus of a plurality of virtual machines in accordance with various example embodiments may further include a display resource management policy acquiring module and/or determining for acquiring and/or determining the pre-configured display resource management policy information.

Only as an example rather than the limitation, in a case where the display resource management policy information includes information of at least one primary display resource and at least one expansion display resource configured for each virtual machine, the display resource allocation management module 410 may be further configured to allocate the idle expansion display resource of the at least one expansion display resource and the at least one primary display resource to the first virtual machine based on the display resource management policy information when the first virtual machine starts. More particularly, the display resource allocation management module 410 may directly allocate the at least one primary display resource to the first virtual machine in a case where the at least one primary display resource is not allocated to the other virtual machines, and the display resource allocation management module 410 may recycle the at least one primary display resource from the other virtual machines to allocate the same to the first virtual machine in a case that the at least one primary display resource is allocated to the other virtual machines.

Only as an example rather than the limitation, the display resource allocation management module 410 may recycle the display resource allocated to the first virtual machine and may allocate the recycled display resource to the operating virtual machine of the other corresponding virtual machines based on the display resource management policy information when the first virtual machine is closed. Here, the display resource allocation management module 410 may allocate the display resource by sending, to the first virtual machine, a display resource virtual hot insertion message indicating the display resource to be allocated, and/or recycle the display resource by sending, to the first virtual machine, a display resource virtual hot pullout message indicating the display resource to be recycled.

Here, the display resource management policy acquiring module and the display resource allocation management module 410 may be arranged in a virtual machine which actually controls display resources of the plurality of virtual machines.

More particularly, as illustrated in FIG. 5, a multi-screen allocation management apparatus 500 of a plurality of virtual machines in accordance with various example embodiments may further include a display front end module 530, a display back end module 540, a display driving module 550 and an input/output (IO) arbitration module 560 in addition to a display resource management policy acquiring module 510 and a display resource allocation management module 520. It should be noted that the multi-screen allocation management apparatus 500 of a plurality of virtual machines in accordance with various example embodiments including a display resource management policy acquiring module 510, a display front end module 530, a display back end module 540, a display driving module 550 and an IO arbitration module 560 is only an example rather than the limitation, and a user and/or an artisan may configure at least one of above respective modules 510, 530-560 according to actual needs and/or to desires. Alternatively or additionally, since the display resource management policy acquiring module 510 and the display resource allocation management module 520 correspond to the display resource management policy acquiring module and the display resource allocation management module 410 described with reference to FIG. 4, respectively, the detailed descriptions thereof will be omitted.

The display front end module 530 may be arranged in a virtual machine 502 which does not actually control display resources in the plurality of virtual machines, the display back end module 540 may be arranged in a virtual machine 501 which actually controls display resources together with the display resource management policy acquiring module 510, the display resource allocation management module 520 and the display driving module 550, and the IO arbitration module 560 may be arranged in a virtual machine hypervisor 503.

As illustrated in FIG. 5, the display back end module 540 may be arranged in the virtual machine 501 together with the display resource management policy acquiring module 510, the display resource allocation management module 520 and the display driving module 550, the display front end module 530 may be arranged in the virtual machine 502, and the IO arbitration module 560 may be arranged in the hypervisor 503.

More particularly, the display front end module 530 may be arranged in a kernel core space of the virtual machine 502, the display back end module 540 may be arranged in a kernel space of the virtual machine 501 together with the display resource allocation management module 520 and the display driving module 550, and the display resource management policy acquiring module 510 may be arranged in a user space or a kernel space of the virtual machine 501.

The display front end module 530 may provide the virtual display device to interact with applications, and/or may interact with the display back end module 540, for example, send a request of an application to the display back end module 540.

The display back end module 540 may interact with the display front end module 530, the display resource allocation management module 520 and the display driving module 550, for example, send a request of an application sent by the display front end module 530 to the display driving module 550 so as to control display resources. When a display resource is allocated to the virtual machine which does not actually control display resources or the display resource is recycled from the virtual machine, the display resource allocation management module 520 may allocate the display resource by sending a display resource virtual hot insertion message indicating the display resource to be allocated to the display front end module 530 among these virtual machines through the display back end module 540, and/or recycle the display resource by sending a display resource virtual hot pullout message indicating the display resource to be recycled to the first virtual machine.

The display driving module 550 may drive display resources based on a request. Here, since the display driving module 550 drives display resources, the virtual machine including the display driving module 550 is the virtual machine which actually controls display resources, while other virtual machine not including the display driving module 550 also need to or intend to or desire to control a display resource through the display driving module 550 after the display resource is allocated, that is to say, other virtual machine not including the display driving module 550 indirectly controls display resources or do not actually control display resources.

The IO arbitration module 560 may connect or disconnect a path between display resources and virtual machines. For example, when a display resource is allocated to a virtual machine which does not actually control display resources, the display resource allocation management module 520 may request the IO arbitration module 560 to connect the path between the display resource and the virtual machine and send a display resource virtual hot insertion message indicating the display resource to be allocated to the virtual machine through the display back end module 540. When a display resource is recycled from a virtual machine, the display resource allocation management module 520 may send a display resource virtual hot pullout message indicating the display resource to be recycled to the virtual machine through the display back end module 540 and request the IO arbitration module 560 to disconnect the path between the display resource and the virtual machine.

Table 1 is an example illustrating display resource management policy information. It should be noted that Table 1 is only an example of display resource management policy information, and may be amended and/or set a value and item number of any item therein according to actual needs and/or desires. In addition, only as an example rather than the limitation, the format of the display resource management policy information may be a form of the following Table 1.

TABLE 1

| | virtual | Primary | | Expansion |
|---|---|---|---|---|
| Operating | machine | display | | Display |
| System | ID | resource | Monopolized | Resource |
| Cluster OS | 1 | Display: 1; | No | No |
| | | Layers: 1, 3, 4 | | |
| IVI OS | 2 | Display: 2; | No | Display: 1; |
| | | Layer: 1 | | Layer: 2 |
| | | Display: 3; | | Display: 4; |
| | | Layers: 1, 4 | | Layer: 3 |
| | | | | Display: 5; |
| | | | | Layer: 3 |
| L-RSE OS | 3 | Display: 4; | No | Display: 2; |
| | | Layers: 1, 4 | | Layer: 2 |
| | | | | Display: 3; |
| | | | | Layer: 2 |
| | | | | Display: 5; |
| | | | | Layer: 2 |
| R-RSE OS | 4 | Display: 5; | Yes | Display: 2; |
| | | Layers: 1, 4 | | Layer: 3 |
| | | | | Display: 3; |
| | | | | Layer: 3 |
| | | | | Display: 4; |
| | | | | Layer: 2 |

As illustrated in Table 1, the multi-screen allocation management apparatus of a plurality of virtual machines in accordance with various example embodiments may include, for example, four virtual machines, the display resource management policy information in the above form may indicate following information.

The operating system of the virtual machine 1 is or may be a Cluster OS, and the primary display resource thereof is or may be layers 1, 3 and 4 in display 1 without expansion display resources. In addition, a monopolized field being “no” may indicate display 1 is not monopolized when the virtual machine 1 is operating, that is, the other virtual machines may use layers other than layers 1, 3 and 4 in display 1.

The operating system of the virtual machine 2 is or may be IVI OS, the primary display resource thereof is layer 1 in display 2 and layers 1 and 4 in display 3, and the expansion display resource is or may be layer 2 in display 1, layer 3 in display 4 and layer 3 in display 5.

The operating system of the virtual machine 3 is or may be the Left Rear Seat Entertainment OS (L-RSE OS), the primary display resource thereof is or may be layers 1 and 4 in display 4 layer, and the expansion display resource is or may be layer 2 in display 2, layer 2 in display 3 and layer 2 in display 5.

The operating system of the virtual machine 4 is or may be the Right Rear Seat Entertainment OS (R-RSE OS), the primary display resource thereof is or may be layers 1 and 4 in display 5, and the expansion display resource is layer 3 in display 2, layer 3 in display 3 and layer 2 in display 4. In addition, a monopolized field being “yes” may indicate display 5 is monopolized when the virtual machine 4 is operating, that is, the other virtual machines cannot use layers in display 5.

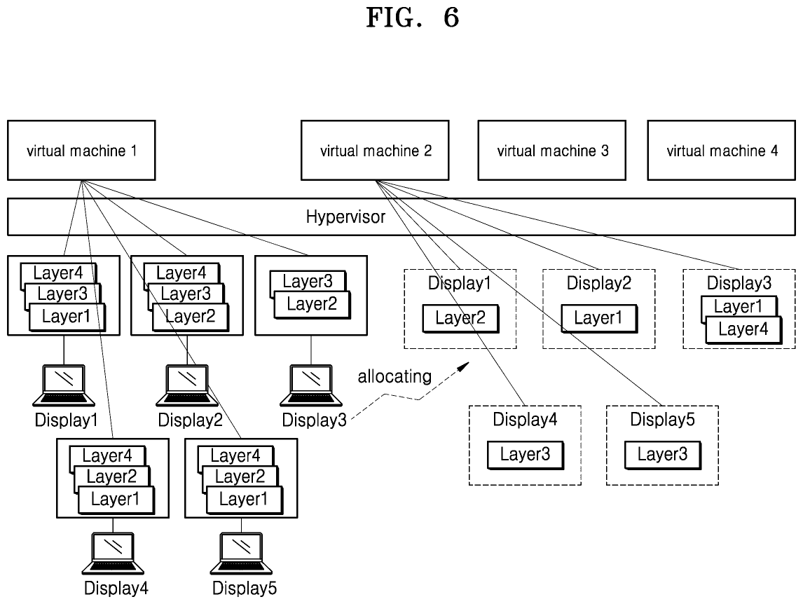

FIG. 6 is a diagram illustrating a multi-screen allocation management apparatus of a plurality of virtual machines operating virtual machines 1 and 2 according to Table 1 in accordance with various example embodiments.

Referring to FIG. 6, when the multi-screen allocation management apparatus of a plurality of virtual machines in accordance with various example embodiments starts, virtual machines 1 and 2 may start by default (while virtual machines 3 and 4 are in a close state). At the time of starting, the Cluster OS of the virtual machine 1 may initialize the display resource management policy acquiring module, the display resource allocation management module and the display back end module, the display resource allocation management module of the virtual machine 1 may request the IO arbitration module to connect layers 1, 3 and 4 in display 1 with the virtual machine 1 (that is, layers 1, 3 and 4 in display 1 are allocated to the virtual machine 1) according to the display resource management policy information acquired by the display resource management policy acquiring module (taking the display resource management policy in Table 1 as an example here). The IVI OS of the virtual machine 2 may initialize the display front end module of the virtual machine 2 and notify the virtual machine 1 of the start state to request display resources. In response to the notification, the display resource allocation management module of the virtual machine 1 may request the IO arbitration module to connect layer 1 in display 2, layers 1 and 4 in display 3, layer 2 in display 1, layer 3 in display 4 and layer 3 in display 5 with the virtual machine 2 according to the display resource management policy information and send a display resource virtual hot insertion and/or pullout message indicating the above display resources to the virtual machine 2 through the display back end module to allocate the above display resources. Alternatively or additionally, the display resources below the virtual machine 1 as illustrated in FIG. 6 may represent layers 1, 3 and 4 of the display 1 allocated to the virtual machine 1 and currently idle display resources which do not have corresponding virtual machines according to the display resource management policy information. As illustrated in FIG. 6, the virtual machine 2 is allocated with display resources of a plurality of displays, has a multi-screen ability and may share and interact with the virtual machine 1.

It should note that the multi-screen allocation management apparatus of a plurality of virtual machines in accordance with various example embodiments as illustrated in FIG. 6 operating the virtual machines 1 and 2 according to Table 1 is only an example rather than the limitation, and those skilled in the art may make amendments according to actual needs.

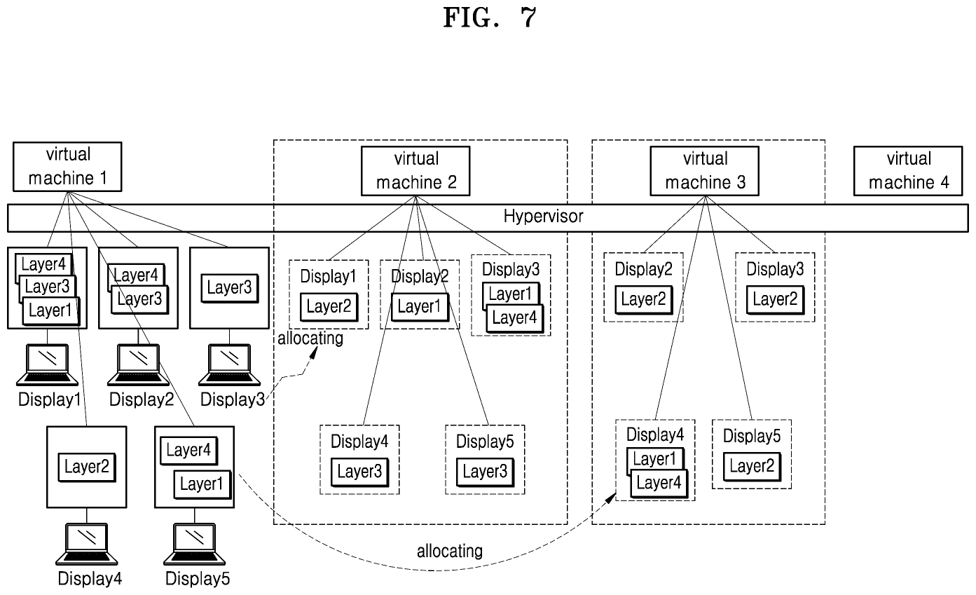

FIG. 7 is a diagram illustrating a multi-screen allocation management apparatus of a plurality of virtual machines operating virtual machine 3 according to Table 1 in accordance with various example embodiments.

Referring to FIG. 7, after the virtual machines 1 and 2 start as above with reference to FIG. 6, when the virtual machine 3 starts, the L-RSE OS of the virtual machine 3 may initialize the display front end module of the virtual machine 3 to notify the virtual machine 1 of the start state to request display resources. In response to the notification, the display resource allocation management module of the virtual machine 1 may request the IO arbitration module to connect layers 1 and 4 in display 4, layer 2 in display 2, layer 2 in display 3 and layer 2 in display 5 with the virtual machine 3 according to the display resource management policy information and send a display resource virtual hot insertion and/or pullout message indicating the above display resources to the virtual machine 3 through the display back end module to allocate the above display resources. Alternatively or additionally, the display resources below the virtual machine 1 are updated simultaneously and/or concurrently, which include layers 1, 3 and 4 of the display 1 allocated to the virtual machine 1 and currently idle display resources which do not have corresponding virtual machines according to the display resource management policy information. As illustrated in FIG. 7, the virtual machine 3 is allocated with display resources of a plurality of displays, has a multi-screen ability and may share and interact with the virtual machine 2.

As should be understood, the operating virtual machine 3 as illustrated in FIG. 7 is only an example rather than the limitation, and those skilled in the art may make amendments according to actual needs.

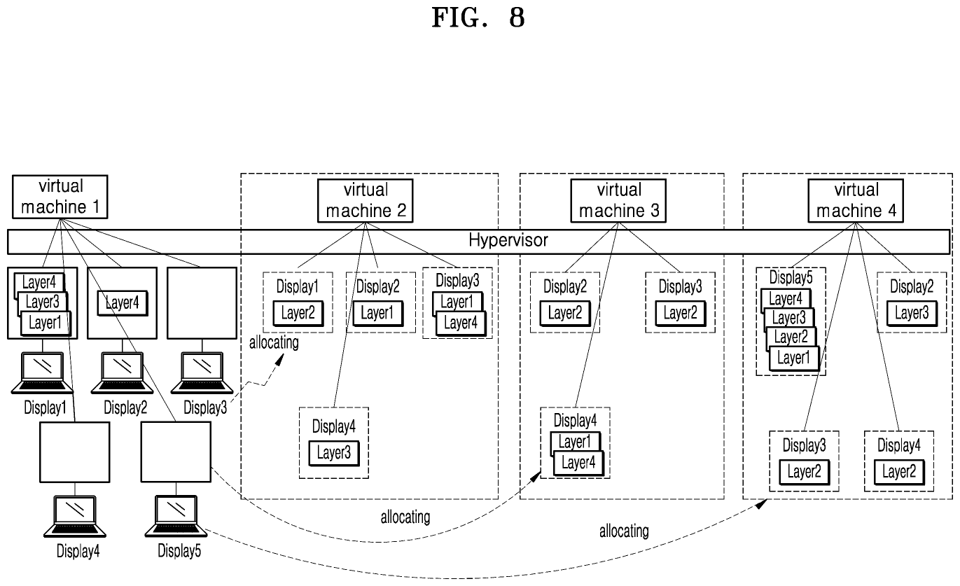

FIG. 8 is a diagram illustrating a multi-screen allocation management apparatus of a plurality of virtual machines operating virtual machine 4 according to Table 1 in accordance with various example embodiments.

Referring to FIG. 8, after the virtual machine 3 starts as above with reference to FIG. 7, when the virtual machine 4 starts, the R-RSE OS of the virtual machine 4 may initialize the display front end module of the virtual machine 4 to notify the virtual machine 1 of the start state to request display resources. In response to the notification, the display resource allocation management module of the virtual machine 1 may request the IO arbitration module to connect layers 1 and 4 in display 5, layer 3 in display 2, layer 3 in display 3 and layer 2 in display 4 with the virtual machine 4 according to the display resource management policy information acquired by the display resource management policy acquiring module and send a display resource virtual hot insertion and/or pullout message indicating the above display resources to the virtual machine 4 through the display back end module to allocate the above display resources. Here, it should be noted that since the virtual machine 4 monopolizes display 5, the display resource allocation management module of the virtual machine 1 should recycle the display resources of display 5 from the virtual machines 2 and 3 through the IO arbitration module and then allocate layers 1 and 4 in display 5 to the virtual machine 4 through the IO arbitration module according to the display resource management policy. Alternatively or additionally, the display resources below the virtual machine 1 are updated simultaneously and/or concurrently, which include layers 1, 3 and 4 of the display 1 allocated to the virtual machine 1 and currently idle display resources which do not have corresponding virtual machines according to the display resource management policy information. As illustrated in FIG. 8, the virtual machine 4 is allocated with display resources of a plurality of displays, has a multi-screen ability and may share and interact with the virtual machines 2 and 3.

In addition to those described above with reference to FIGS. 6, 7 and 8, when a certain virtual machine or a plurality of virtual machines in the virtual machines 2-4 is/are closed, the display resource allocation management module of the virtual machine 1 may recycle the display resources allocated to the virtual machines and allocate the recycled display resources to the operating virtual machines of the other corresponding virtual machines based on display resource management policy information.

In accordance with various example embodiments, the ability to dynamically expand display resources may be provided by reallocating display resources based on display resource management policy information when the virtual machine is shut down or in response to the virtual machine being closed or shut down. Applications in the virtual machine may be enabled to dynamically use a plurality of display resources by allocating a plurality of displays and/or layers in a plurality of displays to the virtual machine so that application scenarios in a multi-screen scenario are expanded. Alternatively or additionally, customization developments of application level software may be reduced as much as possible through development of the driver level, that is, disposing modules such as the display resource allocation management module and the like in the virtual machine which actually controls display resources in the plurality of virtual machines.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Although the present disclosure has been illustrated and described with reference to special various example embodiments, it will be understood by those of ordinary skill in the art that various changes in form and details may be made without departing from the spirit and scope as defined by the claims and their equivalents. Furthermore example embodiments are not necessarily mutually exclusive with one another. For example, some example embodiments may include one or more features described with reference to one or more drawings, and may also include one or more other features described with reference to one or more other drawings.

What is claimed is:

1. A multi-screen allocation management method for a plurality of virtual machines, comprising:
allocating a first display resource to a first virtual machine based on display resource management policy information, the allocating in response to the first virtual machine starting; and
recycling and reallocating the allocated display resource from the first virtual machine based on the display resource management policy information, the recycling and the reallocating in response to the first virtual machine closing,
wherein the display resource management policy information comprises information of at least one display resource configured for each of the plurality of virtual machines, and the first display resource is at least one display resource configured for the first virtual machine.

2. The multi-screen allocation management method of a plurality of virtual machines of claim 1, wherein the display resource management policy information further comprises information of at least one primary display resource and at least one expansion display resource, the at least one expansion display resource configured for each of the plurality of virtual machines.

3. The multi-screen allocation management method of a plurality of virtual machines of claim 2, wherein the allocating the first display resource to the first virtual machine based on display resource management policy information comprises:
allocating an idle expansion display resource of the at least one expansion display resource and the at least one primary display resource to the first virtual machine based on the display resource management policy information, in response to the first virtual machine starting.

4. The multi-screen allocation management method of a plurality of virtual machines of claim 3, wherein the allocating the at least one primary display resource to the first virtual machine based on the display resource management policy information comprises:
directly allocating the at least one primary display resource to the first virtual machine in a case of the at least one primary display resource is not allocated to other virtual machines; and
recycling the at least one primary display resource from the other virtual machines to allocate to the first virtual machine in a case of the at least one primary display resource is allocated to the other virtual machines.

5. The multi-screen allocation management method of a plurality of virtual machines of claim 1, wherein the recycling and reallocating the allocated display resource from the first virtual machine based on the display resource management policy information comprises:
recycling the display resource allocated to the first virtual machine and allocating the recycled display resource to an operating virtual machine of other corresponding virtual machines, based on the display resource management policy information and in response to the first virtual machine being closed.

6. The multi-screen allocation management method of a plurality of virtual machines of claim 1, wherein
the display resource is allocated by sending, to the first virtual machine, a display resource virtual hot insertion message indicating the display resource to be allocated, and/or
the display resource is recycled by sending, to the first virtual machine, a display resource virtual hot pullout message indicating the display resource to be recycled.

7. The multi-screen allocation management method of a plurality of virtual machines of claim 1, wherein the display resource includes a plurality of displays and/or layers in a plurality of displays.

8. A multi-screen allocation management apparatus of a plurality of virtual machines, comprising:
a display resource allocation management processing circuitry configured to allocate a first display resource to a first virtual machine based on display resource management policy information in response to the first virtual machine starting, and to recycle and reallocate the allocated display resource from the first virtual machine based on the display resource management policy information in response to the first virtual machine being closed,
wherein the display resource management policy information comprises information of at least one display resource configured for each of the plurality of virtual machines, and the first display resource is at one display resource configured for the first virtual machine.

9. The multi-screen allocation management apparatus of a plurality of virtual machines of claim 8, wherein the display resource management policy information further comprises information of at least one primary display resource and at least one expansion display resource configured for each virtual machine.

10. The multi-screen allocation management apparatus of a plurality of virtual machines of claim 9, wherein the display resource allocation management processing circuitry is further configured to:
allocate an idle expansion display resource of the at least one expansion display resource and the at least one primary display resource to the first virtual machine based on the display resource management policy information in response to the first virtual machine starting.

11. The multi-screen allocation management apparatus of a plurality of virtual machines of claim 10, wherein the display resource allocation management processing circuitry is further configured to:
directly allocate the at least one primary display resource to the first virtual machine in a case that the at least one primary display resource is not allocated to the other virtual machines; and
recycle the at least one primary display resource from the other virtual machines to allocated to the first virtual machine in a case that the at least one primary display resource is allocated to the other virtual machines.

12. The multi-screen allocation management apparatus of a plurality of virtual machines of 8, wherein the display resource allocation management processing circuitry is further configured to:
recycle the display resource allocated to the first virtual machine and allocate the recycled display resource to an operating virtual machine of the other corresponding virtual machines based on the display resource management policy information in response to the first virtual machine being closed.

13. The multi-screen allocation management apparatus of a plurality of virtual machines of claim 8, wherein the display resource allocation management processing circuitry allocates the display resource by sending, to the first virtual machine, a display resource virtual hot insertion message indicating the display resource to be allocated, and/or recycles the display resource by sending, to the first virtual machine, a display resource virtual hot pullout message indicating the display resource to be recycled.

14. The multi-screen allocation management apparatus of a plurality of virtual machines of claim 8, wherein the display resource includes a plurality of displays and/or layers in a plurality of displays.

15. The multi-screen allocation management apparatus of a plurality of virtual machines of claim 8, wherein the display resource allocation management processing circuitry is arranged in a virtual machine which actually controls display resources of the plurality of virtual machines.

16. A computer readable medium, on which computer executable instructions are stored, which executes the method of claim 1 when the instructions are executed.
